(19) United States
(12) Patent Application Publication
(10) Pub. No.: US 2007/0247613 A1
(43) Pub. Date: Oct. 25, 2007

(54) Fiber optic accelerometer

(76) Inventors: Mathieu Cloutier, Richelieu (CA); Jean Pronovost, St-Mathieu de Beloeil (CA); Marius Cloutier, Longueuil (CA)

Correspondence Address: MUIRHEAD AND SATURNELLI, LLC, 200 FRIBERG PARKWAY, SUITE 1001, WESTBOROUGH, MA, 01581, US

(21) Appl. No.: 11/594,005

(22) Filed: Nov. 7, 2006

Related U.S. Application Data
(60) Provisional application No. 60/794,115, filed on Apr. 24, 2006.

(51) Int. Cl. G01P 3/36; G01C 3/08

(52) U.S. Cl. 356/28; 356/4.07

(57) ABSTRACT

An optical acceleration sensor includes a target having a reflective portion and a non-reflective portion. A conveyor causes light to be irradiated on the target. A receiver receives light from the target. An inertial mass is coupled to at least one of the conveyor and the receiver, wherein movement of the inertial mass relative to the target causes a change in intensity of an amount of light impinging on the portions to change an amount of light received at the receiver. The conveyor and the receiver may be optical fibers and may be disposed at least partially in an opaque conduit and held substantially parallel in a sensor head.

### CROSS-REFERENCE TO RELATED APPLICATIONS

This application claims priority to U.S. Provisional Patent Application No. 60/794,115 filed on Apr. 24, 2006, which is incorporated herein by reference.

### TECHNICAL FIELD

This application is directed to the field of motion sensing and, more particularly, to motion sensing using an optical acceleration sensor such as a fiber optic accelerometer.

### BACKGROUND OF THE INVENTION

Vibration sensing and analysis are useful tools in monitoring and diagnosing performance of machine components and other objects. In particular, vibration analysis may be used to assess the component health of rotating machines such as rotor shafts and bearings as well as inside generators to assess vibration of stator bars and end-windings. An accelerometer may measure the vibration. However, in instances where strong electrical fields may be present, a conventional electronic accelerometer may not be acceptable since the strong electrical fields may interfere with operation of the conventional electronic accelerometer. In such cases, it may be desirable to use fiber optic accelerometers that do not include metallic or conductive components that would be adversely affected in a strong electrical field.

Known vibration analysis systems include the use of optical accelerometers that measure characteristics of light, including light intensity and phase, reflected from a mass which moves in response to accelerations and vibrations. (See for example, U.S. Pat. No. 5,886,265 to Chatrefou, U.S. Pat. No. 4,948,255 to Watanabe, and U.S. Pat. No. 3,789,674 to Anderson, et al., which are incorporated herein by reference.) Vibrations may also be determined by analyzing birefringence of light reflected from parallel, partially reflective plates that move with respect to each other, such as by Fabry-Perot interferometry. (See, for example, U.S. Pat. No. 6,921,894 to Swierkowski, U.S. Pat. No. 6,494,095 to Wan, and U.S. Pat. No. 5,182,612 to Rhême, which are incorporated herein by reference.) Such interferometry analysis is generally complex and may be expensive to implement and operate.

Accordingly, it is desirable to provide an optical acceleration sensor for vibration and other motion analysis that may be fabricated, implemented and operated simply and at relatively low cost.

### SUMMARY OF THE INVENTION

According to the system described herein, a sensor includes a target having a reflective portion and a non-reflective portion. A conveyor causes light to be irradiated on the target. A receiver receives light from the target. An inertial mass is coupled to at least one of the conveyor and the receiver, wherein movement of the inertial mass relative to the target causes a change in intensity of an amount of light impinging on the reflective portion and the non-reflective portion to change an amount of light received at the receiver.

The conveyor and the receiver may be optical fibers and may be disposed at least partially in an opaque conduit and held substantially parallel. Ends of the optical fibers may face the target and extend by a jutting portion beyond the inertial mass, wherein acceleration components between 0.5 g and 160 g cause both of the ends of the fibers to move with a substantially identical movement response. The inertial mass may be attached to both the conveyor and the receiver so that movement of the inertial mass causes a substantially identical movement of the conveyor and the receiver.

The target may include a two-face mirror having first and second faces disposed at a 90 degree angle with respect to each other and at a 45 degree angle with respect to incident and reflected light beam paths. The change in light intensity of the light received by the receiver may be responsive to movement of the inertial mass in one dimension only, that may be transversal to a plane of the conveyor and the receiver or perpendicular to an interface of the non-reflective portion and the reflective portion, and the movement of the inertial mass may include deflection resulting from vibration. The change in intensity may result from occulting a portion of a luminous spot formed from incident light on the first face before the being reflected into the receiver, the occultation being a function of the location of the luminous spot on the first face of the mirror. A first amount of the luminous spot reflected to the receiver may be inversely proportional to a second amount of the luminous spot that strikes the non-reflective portion.

The inertial mass, target and ends of the conveyor and receiver may be disposed in a sensor head that has at least one flat edge to align the sensor, and all made of electrically non-conducting materials. The sensor may further include a light source coupled to the conveyor, a detector coupled to the receiver that measures the change in light intensity, and a luminous intensity analyzer coupled to the detector that determines an extent of the movement of the inertial mass based on the change in light intensity.

According further to the system described herein, a target for a fiber optic sensor unit includes a reflective portion that receives a first variable amount of an incident light beam and a non-reflective portion that receives a second variable amount of an incident light beam. Movement of an inertial mass separate from the target causes the first variable amount of the incident light beam and the second variable amount of the incident light beam to vary according to the movement of the inertial mass.

The reflective and non-reflective portions may be disposed on a two-face mirror having first and second faces, both faces forming together an approximately 90 degree angle, the first face receiving the incident light beam under a first incident angle of approximately 45 degrees and reflecting an internally-reflected light beam onto the second face under a second incident angle of approximately 45 degrees, the second face reflecting the internally-reflected light beam received from the first face. The non-reflective portion may occult part of a luminous spot resulting from the incident light beam on the first face of the mirror before being reflected into the receiver, the occultation being a function of the location of the luminous spot on the first face. Any change in intensity of the light received by the receiver may be responsive in only one dimension of any movement or component thereof of the inertial mass. The one dimension may be transversal to a plane of the conveyor and the receiver or perpendicular to an interface of the non-reflective portion and the reflective portion. A first amount of the luminous spot reflected to the receiver may be inversely proportional to a second amount of the luminous spot that strikes the non-reflective portion.

According further to the system described herein, a method of determining motion of an object includes providing a target having a reflective portion and a non-reflective portion.

A conveyor is provided that causes light to be irradiated on the target and a receiver is provided that receives light from the target. An inertial mass is coupled to at least one of the conveyor and the receiver, wherein movement of the inertial mass relative to the target causes a change in intensity of an amount of light impinging on the reflective portion and the non-reflective portion to change an amount of light received at the receiver. The change in intensity is measured and used to determining movement of the object. The conveyor and the receiver may be optical fibers. The inertial mass may be attached to both the conveyor and the receiver so that movement of the inertial mass causes a substantially identical movement of the conveyor and receiver. The change in light intensity of the light received by the receiver may be responsive to movement of the inertial mass in one dimension only.

According further to the system described herein, a fiber optic sensor unit includes a target that receives an incident light beam and outputs a reflected light beam. The target includes a reflective portion, wherein movement of the incident light beam with respect to the reflective portion causes a change in intensity of the reflected light beam according to movement of the incident light beam in one dimension only. The target may further include a non-reflective portion that receives a variable amount of the incident light beam, wherein movement of the incident light beam causes the variable amount of the incident light beam impinging on the non-reflective portion to vary according to the movement of the incident light beam and causes the change in intensity of the reflected light beam. The movement of the incident light beam may be caused by movement of an inertial mass separate from the target.

### BRIEF DESCRIPTION OF THE DRAWINGS

Embodiments of the system are described with reference to the several figures of the drawings, in which:

FIG. 1 is a schematic view of an embodiment of an optical accelerometer sensor according to the system described herein.

FIG. 2 is a schematic view of a sensor head for an optical accelerometer sensor according to the system described herein.

FIG. 3 is a differently oriented schematic view of the sensor head shown in FIG. 2 according to the system described herein.

FIG. 4 is a schematic illustration of a two-face mirror incorporated into the sensor head, seen from the point of view of the incident light, according to the system described herein.

FIG. 5 is a schematic view of another embodiment of the optical accelerometer sensor according to the system described herein.

### DETAILED DESCRIPTION OF VARIOUS EMBODIMENTS

Referring now to the figures of the drawings, the figures comprise a part of this specification and illustrate exemplary embodiments of the described system. It is to be understood that in some instances various aspects of the system may be shown schematically or may be exaggerated or altered to facilitate an understanding of the system.

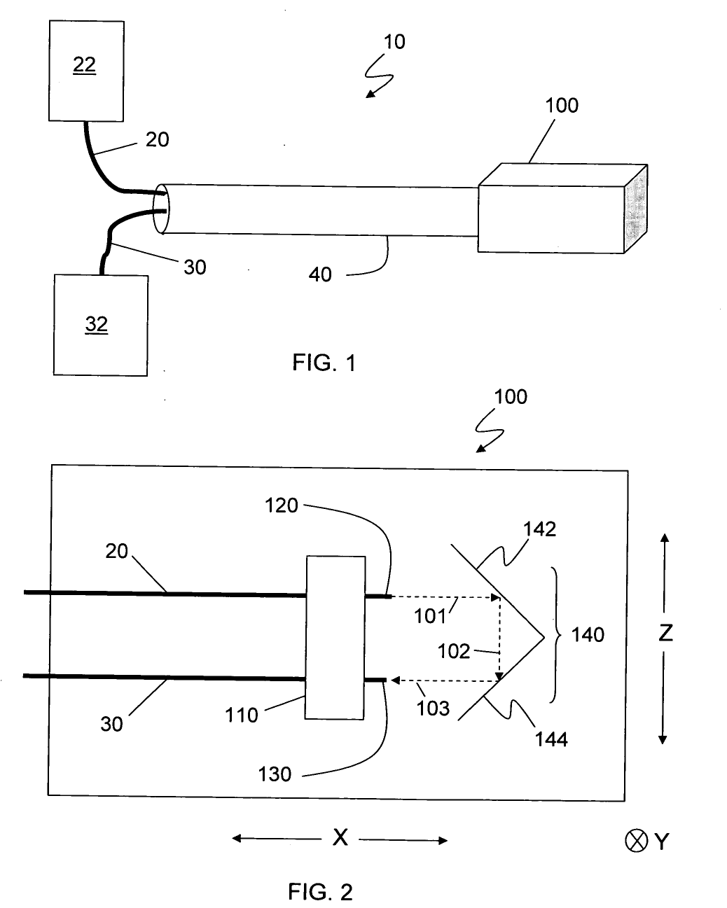

FIG. 1 is a schematic illustration of an embodiment of an optical acceleration sensor 10 according to the system described herein. Optical fibers 20, 30 are positioned in a conduit 40 that is coupled to a fiber optic accelerometer sensor head 100. The conduit 40 may be opaque. One fiber optic 20 acts a light conveyor and is coupled to a light source 22. The other fiber optic 30 acts as a light receiver and is coupled to a detector unit 32. The fiber optic accelerometer sensor head 100 is attached to an object for which a determination of motion, e.g. vibration, is desired. Alternatively, in other embodiments, it is possible for one fiber optic to act as both the conveyor and the receiver. Although optical fibers are referenced in the figures, it is contemplated that other light conveyors and receivers are possible for use with the system described herein. For example, the system may be configured such that the light conveyor of the system is the direct light source mounted in the sensor head 100 without an intervening optical fiber.

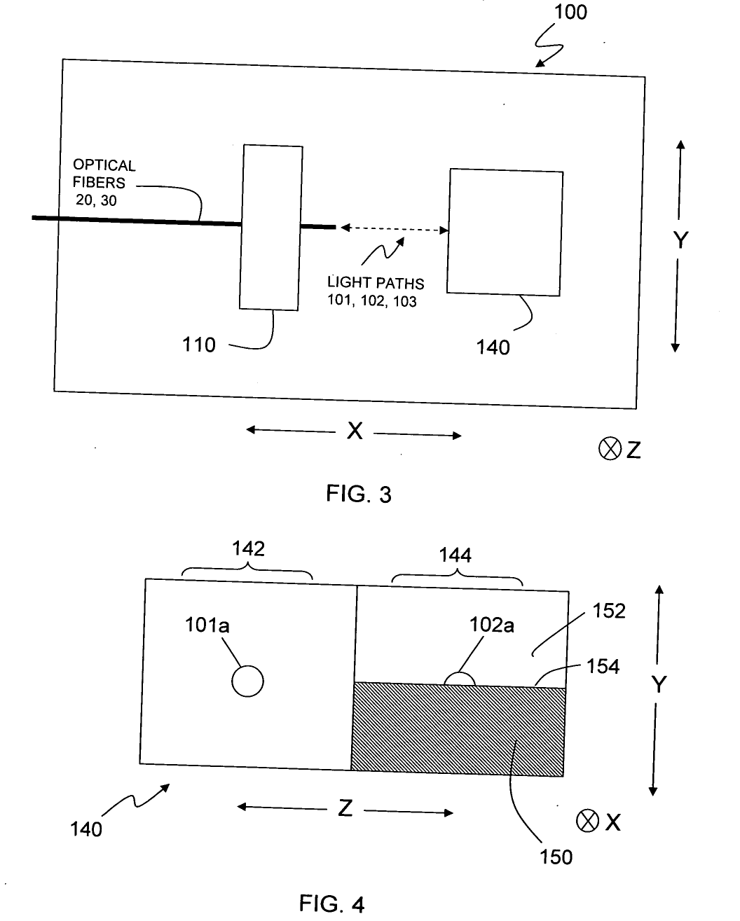

FIGS. 2 and 3 illustrate differently oriented views of an embodiment of the sensor head 100 of the optical acceleration sensor 10 according to the system described herein. The dimensions labeled “X”, “Y”, and “Z” illustrate the relative orientation of FIGS. 2 and 3 (and FIG. 4). The sensor head 100 contains the two optical fibers 20, 30 that are coupled together by an inertial mass 110. Ends 120, 130 of the fibers 20, 30 may jut out beyond the inertial mass 110 and face a reflective target, such as a mirror 140. The amount that the ends 120, 130 jut out beyond the inertial mass 110 may vary and could, in some embodiments, be zero (i.e., there are no ends 120, 130). The fiber 20, 30 are cantilevered by the inertial mass 110 which may further hold the fiber ends 120, 130 rigidly and in parallel. In the embodiment, shown, the sensor head 100 has cubic proportions that allows the sensor head to be placed in a number of positions so as to be flat against a surface of the object for which vibration is to be measured. In other embodiments, the sensor head may have at least one flat edge that contacts the object and/or at least one surface that substantially form fits or is in some way physically alignable, more or less, with the object for which vibrations are being measured. The sensor head may include any shape with markings thereon to indicate appropriate positioning of the sensor head against the object. The sensor head may be sized as desired according to criteria for its application of use, but it should be noted that the size of the sensor head may be very small because optical saturation may occur when the movement of the inertial mass exceeds the diameter of the optical fiber which can be very small.

Light of a given luminous intensity travels from light source 22 through the fiber 20 and strikes a first reflecting surface 142 of the mirror 140 along a light path 101. The first reflecting surface of the mirror 140 forms an approximately 45° angle with the light path 101 of the incident light. The incident light is then reflected with an approximately 90° angle along a light path 102 to the second reflecting surface 144 of the mirror 140 which forms an approximately 90° orthogonal plane with the first reflecting surface 142 of the mirror 140. Incident light on the second reflecting surface 144 of the mirror 140 is reflected again along a light path 103 as light which is parallel to the initial incident light and oriented in the opposite direction of the initial incident light. The end 130 of the second fiber 30 may be located so as to receive the light reflected from the second reflecting surface 144 along the light path 103 and the differential between the luminous intensities of the incident light conveyed by the fiber 20 and the reflected light received by the fiber 30 can be measured. The differential may be established by the detector 32 that may be a photoreceptor or other device to measure luminous intensity. Note that angles other than those illustrated herein may be used. Further, it should be noted that, in other embodiments, the system described herein may operate even without the use of a mask or non-reflective portion. That is, even without a mask or non-reflective portion, upon an acceleration of the inertial mass, the angle with which the light signal hits the mirror will vary which will affect the light signal's intensity, albeit by a very small amount.

FIG. 4 shows that a lower part of the second reflecting surface 144 includes a partially masked or non-reflective portion 150 and an upper part that includes a reflective portion 152. The term “portion” used in the context herein may refer to one or more areas or subsets and which, in the case of multiple areas or subsets, may be integrally connected or separate from one other. An interface 154 is defined by a border between the reflective portion 152 and the non-reflective portion 150. The characteristics of the interface 154, including a shape thereof, may affect the vibration detecting characteristics of the sensor 100, as described in more detail elsewhere herein.

Light strikes the first reflecting surface 142 of the mirror 140, forming a luminous spot 101a, which may be a circle in the case of cylindrical projection of the light from the fiber 20. At the resting position of the sensor, when no accelerations or vibrations occur, the fibers ends 120 and 130 and mirror 140 may be positioned in such a way that incident light creates the luminous spot 101a that is then reflected onto the second reflecting surface 144 of the mirror 140. A portion of the light impinging the second reflecting surface 144 is occulted, or otherwise not reflected, due to the non-reflective portion 150 and a portion of the light is reflected as a luminous spot 102a into the fiber 30.

In an embodiment, the differential between the luminous intensities of the incident light conveyed by the fiber 20 from the light source 22 and the reflected light received by the fiber 30 results from movement of the luminous spot 102a about the interface 154 of the non-reflective portion 150 and the reflective portion 152 of the mirror 140. A first amount of the luminous spot 102a is reflected from the reflective portion 152 to the optical fiber 30 while a second amount of the luminous spot 102a strikes the non-reflective portion 150. The first amount may be inversely proportional to the second amount in that when the first amount increases the second amount decreases and vice versa. The sum of the first amount and second amount may be a substantially constant value. In some cases, the first amount or the second amount could be zero. In embodiments where the interface 154 is a straight line, the sensor 100 may detect motion in only one direction (i.e., a direction perpendicular to the line formed by the interface 154). In FIG. 4, the Y dimension is meant to illustrate the direction perpendicular to the line formed by the interface 154.

Although the non-reflective portion 150 is shown as part of the second reflecting surface 144 of the mirror 140, it is contemplated that the non-reflective portion 150 may be incorporated on the first reflecting surface 142 or on both of the surfaces 142, 144. The term “non-reflective” in reference to the non-reflective portion 150 is used generally to indicate a portion that is less reflective than the reflective portion 152 of the mirror 140 and, for example, may be partially non-reflective or substantially completely non-reflective. Further, a design for the mirror 140, according to the system described herein, may include a non-reflective portion 150 that is off of the edge of the mirror. That is, a portion of the incident light beam to the mirror 140 may be reflected by a reflecting surface of the mirror 140 while a portion of the incident light beam may not be reflected because the non-reflected portion of the light beam passes by an edge of the mirror 140 and does not strike the reflecting surface.

When the sensor head 100 is subjected to accelerations or vibrations, the size of the luminous spot 102a may expand and shrink in response thereto based on movement around the interface of the non-reflective portion 150 and the reflective portion 152 of the mirror 140, and the luminous intensity of the luminous spot 102a increases and decreases accordingly. It should be noted that the term “acceleration” used herein may refer to both positive acceleration and negative acceleration (deceleration) and that the term “dimension” used herein may refer to movement in a positive or negative direction. For purposes of the discussion herein, it may be useful to adopt a convention where positive acceleration corresponds to movement in the upward direction in the Y dimension as shown in FIG. 4 and negative acceleration corresponds to movement in the downward direction in the Y dimension as shown in FIG. 4. Of course, the system described herein measures acceleration in any orientation and the choice of a positive direction and a negative direction does not depend on any particular orientation.

In the case of deflection of the inertial mass in a negative direction in the Y dimension as shown in FIG. 4, the size of the luminous spot 102a may be caused to shrink as a result of a greater amount of the light striking the non-reflective portion 150 (or a smaller amount of the light striking the reflective portion 152) and, accordingly, the luminous intensity of the luminous spot 102a reflected into the fiber 30 decreases. In the case of deflection of the inertial mass in the positive direction in the Y dimension as shown in FIG. 4, the size of the luminous spot 102a may be caused to expand as a result of a smaller amount of the light striking the non-reflective portion 150 (or a greater amount of the light striking the reflective portion 152) and, accordingly, the luminous intensity of the luminous spot 102a reflected into the fiber 30 increases.

As shown, movement in the X dimension or the Z dimension is designed to not appreciably change the intensity of the reflected light received by the fiber 30, whereas, as noted above, movement in the Y dimension is designed to change the intensity of the reflected light. Accordingly, the system described herein may provide for detection of movement (acceleration) in one dimension only. The measured movement may be considered as the movement component that is transversal to a plane formed by the conveyor and receiver. Alternatively, the measured movement may be considered as the movement component that is perpendicular to the interface of the non-reflective portion and the reflective portion.

The system described herein provides for vibration analysis in response to acceleration components between any appropriate measuring range, such ranges of 500 to several thousand g,.01 g to .1 g, or any other appropriate range. For some embodiments, the measuring range may be between 0.1 g and 20 g, although sensors having a measuring range of 0.5 g to 160 g may be commercially useful in both what is measured and the availability and combinability of materials used for the sensors. The measuring range depends upon, among other things, the length and stiffness of the optical fibers 20, 30 and the amount (weight) of the mass 110. Note also that it may be possible to measure a relatively large range (e.g., .01 g to several thousand g's) by providing several sensors calibrated for different sub-ranges.

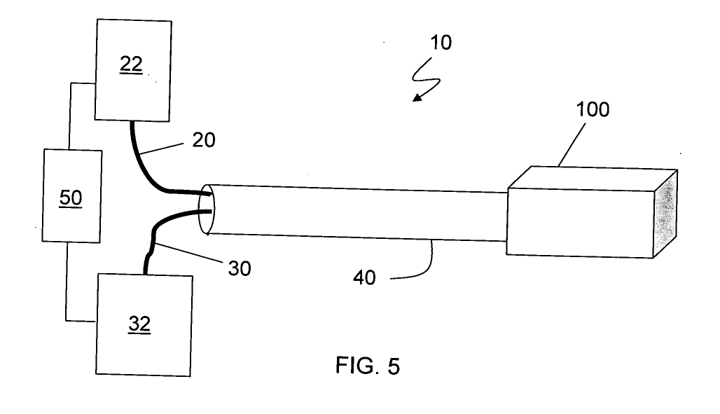

FIG. 5 shows a schematic illustration of an optical acceleration sensor 10 having similar components as described with respect to FIG. 1 and further illustrating a luminous intensity analyzer 50 that may translate the variations in luminous intensity into the accelerations or frequencies and amplitudes of vibrations which are causing such variations. The luminous intensity analyzer 50 may include analog-to-digital conversion circuitry and/or appropriate computing circuitry (e.g., a conventional processing device such as a PC) and/or output circuitry (e.g., a display or appropriate circuitry to output a digital or analog signal indicative of the accelerations).

The luminous intensity analyzer 50 may be a stand-alone unit that is coupled to the detector 32 and/or the light source 22 to analyze the differential between the conveyed light from the light source 22 and the light received by detector 32 and determine an extent of movement of the inertial mass (and, accordingly, the object to which the optical acceleration sensor is attached) based on the change in light intensity. Alternatively, the luminous intensity analyzer 50 may form a part of the detector 32, for example as a processor component therein.

In various embodiments, the sensor may be fabricated using no metallic or electrically-conductive parts so as to allow operation in an environment having an electric or electromagnetic field. For example, non-electrically conducting fiber optical material may be used for the conveyor and the receiver and various ceramic materials used for other components that may be selected depending on particular criteria for an application. For example, materials may be selected that are suitable for low temperature operation, room-temperature operation and/or high temperature operation or selected as suitable materials over a varying temperature range. In particular, for example, the opaque conduit containing the conveyor and the receiver may be comprised of commercially-available ceramics, the outer housing of the sensor head may be comprised of commercially-available ceramics, and the inertial mass connected to the conveyor and the receiver may be comprised of commercially-available ceramics. In an embodiment herein, the ceramic material may be Macor® machinable glass ceramic provided by Corning Incorporated of Coming, NY, although any other suitable materials, such as other machinable glass ceramic materials, may be used.

Further, the non-reflective portion of the mirror may be designed as a portion less reflective than the reflective portion and may be comprised of commercially-available ceramics. The non-reflective portion may be implemented using non-reflective paint or by sandblasting a mirror portion. In other embodiments, it is possible to provide a mirror that is 100% reflective and then use an adjustable but fixed obstacle (like a screw) interposed in the path of at least some of the light. For example, an obstacle could be used to interfere with some of the light that would have otherwise reflected from the first reflecting surface 142 to the second reflecting surface 142.

The system described herein offers various structural and operational advantages. As noted above, in an embodiment where no metallic or electrically-conductive part or component are used, the sensor may operate in electric or electromagnetic fields existing in electric machines or in all environments where static electricity is prohibited. The sensor head may be very small, rugged and precise since there are no moving parts except for the relatively small movement of the cantilevered ends of the two fibers. Both fibers may be cantilevered with the same inertial mass, which ensures that both fibers react substantially identically to the same accelerations or vibrations, thereby reducing a source of error or possible bias that might otherwise occur between the incident light and the reflected light. The sensor may measure and identify not only the amount of accelerations or vibrations but also the direction of the accelerations or vibrations (e.g., whether and when the accelerations or vibrations are negative or positive). Further, in the case of oblique or rotational movements, the 90° mirror arrangement eliminates certain motion components, such that the sensor may measure a single dimensional component of any movement, for example the Y dimension as shown in the figures. The sensor may be low cost since no special light emission, special optical fiber grating, nor a special mirror shape or composition are required. Moreover, the use and modus operandi of the sensor may also be conducted simply and at low cost because the upstream luminosity analysis is straightforward and does not require Fabry-Perot or other relatively complex analysis.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A sensor, comprising:
a target having a reflective portion and a non-reflective portion;
a conveyor that causes light to be irradiated on the target;
a receiver that receives light from the target;
an inertial mass coupled to at least one of the conveyor and the receiver, wherein movement of the inertial mass relative to the target causes a change in intensity of an amount of light impinging on the reflective portion and the non-reflective portion to change an amount of light received at the receiver.

2. The sensor according to claim 1, wherein the conveyor and the receiver are optical fibers.

3. The sensor according to claim 2, wherein the optical fibers are at least partially disposed in an opaque conduit.

4. The sensor according to claim 3, wherein the optical fibers are held substantially parallel in said conduit.

5. The sensor according to claim 2, wherein ends of the first and second optical fibers face the target and extend by a jutting portion beyond the inertial mass in a direction toward the target, and wherein acceleration components between 0.5 g and 160 g cause both of the ends of the optical fibers to move with a substantially identical movement response.

6. The sensor according to claim 1, wherein the inertial mass is attached to both the conveyor and the receiver so that movement of the inertial mass causes a substantially identical movement of the conveyor and the receiver.

7. The sensor according to claim 1, wherein the target includes a two-face mirror having first and second faces disposed at an approximately 90 degree angle with respect to each other, the first face receiving from the conveyor incident light at a first incident angle of approximately 45 degrees and reflecting the incident light onto the second face at a second incident angle of approximately 45 degrees, the second face reflecting the incident light received from the first face to the receiver.

8. The sensor according to claim 7, wherein the non-reflective portion is disposed on at least one of the first and second faces and occults part of a luminous spot resulting from incident light on the first face of the mirror before being reflected into the receiver, a relative importance of the occultation being a function of the location of the luminous spot on the first face of the mirror.

9. The sensor according to claim 8, wherein any change in light intensity of the light received by the receiver is responsive in only a dimension transversal to a plane formed by the conveyor and the receiver to any movement or component thereof of the inertial mass, the movement or component thereof causing a corresponding change in the location of the luminous spot on the first face of the mirror, the 90 degree arrangement of the mirror automatically eliminating non-transversal components of the movement in the intensity of the light reflected into the receiver.

10. The sensor according to claim 7, wherein the non-reflective portion is disposed on at least one of the first and second faces, and wherein a first amount of a luminous spot is reflected to the receiver, the first amount being inversely proportional to a second amount of the luminous spot that strikes the non-reflective portion.

11. The sensor according to claim 10, wherein movement of the luminous spot at an interface between the non-reflective portion and the reflective portion causes the first amount of a luminous spot and the second amount of the luminous spot to vary according to movement of the luminous spot in only one dimension.

12. The sensor according to claim 11 wherein the only one dimension is perpendicular to the interface between the non-reflective portion and the reflective portion.

13. The sensor according to claim 1, wherein the change in light intensity of the light received by the receiver is responsive to movement of the inertial mass in one dimension only.

14. The sensor according to claim 1, wherein the movement of the inertial mass includes deflection resulting from vibration.

15. The sensor according to claim 1, further comprising:
a sensor head that houses the inertial mass, the target, and at least a portion of the conveyor and the receiver.

16. The sensor according to claim 15, wherein the sensor head has at least one flat edge to align the sensor.

17. The sensor according to claim 1, wherein the inertial mass, the target, and ends of the conveyor and the receiver are made of electrically non-conducting materials.

18. The sensor according to claim 1, further comprising:
a detector coupled to the receiver that measures the change in light intensity.

19. The sensor according to claim 18, further comprising:
a luminous intensity analyzer coupled to the detector that determines an extent of the movement of the inertial mass based on the change in light intensity.

20. The sensor according to claim 1, further comprising:
a light source coupled to the conveyor.

21. A target for a fiber optic sensor unit, comprising:
a reflective portion that receives a first variable amount of an incident light beam; and a non-reflective portion that receives a second variable amount of an incident light beam, wherein movement of an inertial mass separate from the target causes the first variable amount of the incident light beam and the second variable amount of the incident light beam to vary according to the movement of the inertial mass.

22. The target according to claim 21, wherein the reflective and non-reflective portions are disposed on a two-face mirror having first and second faces, both faces forming together an approximately 90 degree angle, the first face receiving the incident light beam under a first incident angle of approximately 45 degrees and reflecting an internally-reflected light beam onto the second face under a second incident angle of approximately 45 degrees, the second face reflecting the internally-reflected light beam received from the first face.

23. The target according to claim 21, wherein the non-reflective portion is disposed on at least one of the first and second faces and occults part of a luminous spot resulting from the incident light beam on the first face of the mirror before being finally reflected into the receiver, a relative importance of the occultation being a function of the location of the luminous spot on the first face of the mirror.

24. The target according to claim 23, wherein any change in light intensity of the light received by the receiver is responsive in only a dimension transversal to a plane formed by the conveyor and the receiver to any movement or component thereof of the inertial mass, the movement or component thereof causing a corresponding change in the location of the luminous spot on the first face of the mirror, the 90 degree arrangement of the mirror automatically eliminating non-transversal components of the movement in the intensity of the light reflected into the receiver.

25. The target according to claim 21, wherein the non-reflective portion is disposed on at least one of the first and second faces, and wherein a first amount of a luminous spot of the incident light beam is reflected from the target, the first amount being inversely proportional to a second amount of the luminous spot that strikes the non-reflective portion.

26. The target according to claim 25, wherein movement of the luminous spot at an interface between the non-reflective portion and the reflective portion causes the first amount of the luminous spot and the second amount of the luminous spot to vary according to movement of the luminous spot in only one dimension.

27. The target according to claim 26, wherein the only one dimension is perpendicular to the interface between the non-reflective portion and the reflective portion.

28. A method of determining motion of an object, comprising:
providing a target having a reflective portion and a non-reflective portion;
providing a conveyor that causes light to be irradiated on the target;
providing a receiver that receives light from the target;
providing an inertial mass coupled to at least one of the conveyor and the receiver, wherein movement of the inertial mass relative to the target causes a change in intensity of an amount of light impinging on the reflective portion and the non-reflective portion to change an amount of light received at the receiver;
measuring the change in light intensity; and
determining movement of the object based on the change in light intensity.

29. The method according to claim 28, wherein the conveyor and the receiver are optical fibers.

30. The method according to claim 28, further comprising:
attaching the inertial mass to both the conveyor and the receiver so that movement of the inertial mass causes a substantially identical movement of the conveyor and the receiver.

31. The method according to claim 28, wherein the change in light intensity of the light received by the receiver is responsive to movement of the inertial mass in one dimension only.

32. A fiber optic sensor unit, comprising:
a target that receives an incident light beam and outputs a reflected light beam, the target including a reflective portion, wherein movement of the incident light beam with respect to the reflective portion causes a change in intensity of the reflected light beam according to movement of the incident light beam in only one dimension.

33. The sensor unit according to claim 32, wherein said target further comprises:
a non-reflective portion that receives a variable amount of the incident light beam, and wherein movement of the incident light beam causes the variable amount of the incident light beam impinging on the non-reflective portion to vary according to the movement of the incident light beam and causes the change in intensity of the reflected light beam.

34. The senor unit according to claim 33, wherein the only one dimension is perpendicular to an interface between the reflective portion and the non-reflective portion.

35. The sensor unit according to claim 32, further comprising:
an inertial mass that is separate from the target, wherein the movement of the incident light beam is caused by movement of the inertial mass.

36. The sensor unit according to claim 35, further comprising:
a conveyor coupled to the inertial that causes light to be irradiated on the target; and
a receiver coupled to the inertial mass that receives light from the target.

37. The sensor unit according to claim 36, wherein the only one dimension is transversal to a plane formed by the conveyor and the receiver.
